(19) United States
(12) Patent Application Publication
(10) Pub. No.: US 2021/0395045 A1
(43) Pub. Date: Dec. 23, 2021

(54) ELEVATOR

(71) Applicant: Inventio AG, Hergiswil (CH)

(72) Inventors: LEOPOLDO OBREGON, Luzern (CH); RAHUL DHUMAL, Pune Maharashtra (IN); VISHAL BHOSALE, Pune Maharashtra (IN)

(21) Appl. No.: 17/309,242

(22) PCT Filed: Dec. 13, 2019
(86) PCT No.: PCT/EP2019/085018

§ 371 Date: May 11, 2021

(30) Foreign Application Priority Data
Dec. 17, 2018 (IN) 201841047653

(51) Int. Cl. B66B 17/12; B66B 11/02; B66B 11/00

(52) U.S. Cl. CPC B66B 17/12; B66B 11/0055; B66B 11/0206

(57) ABSTRACT

An elevator includes an elevator car movable in a shaft and a counterweight. The counterweight is connected by suspension apparatus guided over deflecting rollers of a deflecting unit. The counterweight deflecting unit includes a cover arrangement, for covering the deflecting rollers, that is a plastic folding part formed from an erectable blank. The blank has a cover and side walls surrounded by folding lines or edges, wherein the cover and the side walls, in a starting position, lie on a common plane and wherein the cover and the side walls, in an end position, form a cover portion, a front side wall, a rear side wall and transverse side walls, the side walls adjoining the cover portion at right angles.

### FIELD

The invention relates to an elevator with an elevator car and a counterweight supported by a suspension means, wherein at least one of the car and/or the counterweight is connected with the suspension means by at least one deflecting unit. Further, the invention relates to a cover arrangement for a deflecting unit of the elevator car or a counterweight of an elevator.

### BACKGROUND

Elevators are usually installed in a shaft in a building and serve for the transport of persons or goods. The elevator car, which is movable in vertical direction in the shaft, is supported by suspension means in the form of, for example, cables or belts, wherein the suspension means are, for movement of the car, connected with a drive. Depending on the respective design of the elevator installation the car and/or a counterweight connected with the car by way of the support means is or are connected with the suspension means by way of one or more deflecting units. In the case of a 2:1 suspension, for example, one or two deflecting units are associated with the car and one deflecting unit is associated with the counterweight.

JP 2015-137161 A shows a cover arrangement for a deflecting unit of a counterweight. This cover arrangement, however, has a complicated and expensive design.

### SUMMARY

It is accordingly an object of the present invention to avoid the disadvantages of the prior art and, in particular, to create an elevator with an improved cover arrangement for a deflecting unit of an elevator car or a counterweight. The deflecting unit for the elevator shall be of simple construction and able to be produced simply and at low cost.

According to the invention this object is fulfilled by an elevator with the features according to the following description. The elevator comprises an elevator car, which is movable in a shaft, and a counterweight, wherein the elevator car and/or the counterweight are connected by suspension means guided over at least one deflecting roller of a deflecting unit. The deflecting unit comprises a cover arrangement for covering the at least one deflecting roller. The cover arrangement may be used for dust protection and other external influences in the shaft. Further, the cover arrangement may also be helpful for protecting persons when doing maintenance works or inspection. When the car is in motion an incidental injury by moving parts can be avoided. Finally, especially when using belts as suspension means the cover arrangement avoids an undesired jump of the belts from the deflecting roller. Due to the fact that the cover arrangement is a non-metallic folding part formed from a preferably one-piece erectable blank, the costs for the cover arrangement can be significantly reduced. Further, the handling of the cover arrangement is simple and the installation effort is reduced.

The elevator car and/or the counterweight may be suspended via the deflecting unit in the ratio of 2:1. The deflecting unit may be arranged on an upper side of the car or the counterweight.

In a first form of embodiment the cover arrangement is a plastic folding part. One-piece erectable blanks made of plastic material can be manufactured very easily and cost-effectively. A further advantage is that the cover arrangement made of plastic material is light in weight. So, an easy handling with respect to the installation can also be ensured.

It may be advantageous if the blank for the cover arrangement comprises preferably rectangular cover and wall segments surrounded by folding lines or edges. Said cover and wall segments, in a starting position, lie on a common plane. The cover and wall segments, in an end position, define a cover portion and side walls, whereas the side walls adjoin the cover portion preferably at right angles. The side walls may adjoin the cover portion directly or indirectly. This arrangement is distinguished by a relatively low material expenditure.

Preferably, the folding lines are formed by prefabricated grooves in the blank. However, it is possible that the folding lines are perforated or other types or folding lines.

Moreover, it can be advantageous if the cover arrangement comprises a cover portion, a front side wall and a rear side wall located opposite. The cover portion and the front side wall on the one side and the cover portion and the rear side wall on the other side are connected by an articulation strip.

The deflecting unit may further comprise an axle. The at least one deflecting roller may be freely rotatable mounted on said axle. The deflecting unit might have at least two rollers, whereas the rollers are arranged at opposite ends of the axle. The axle might be an elongated axle having two roller receiving sections for the deflecting rollers and an intermediate shaft portion connecting the roller receiving sections, whereas the intermediate shaft portion has a length dimension with respect to the axial direction which can be significantly large than the ones of the roller receiving sections. In this case, the cover and wall segments defining the cover portion, the front side wall and the rear side walls have an elongated rectangular shape, whereas the cover portion, the front side wall and the rear side walls have longitudinal dimensions corresponding to the axle length.

When the cover arrangement is in an end position, the cover portion may be in a horizontal plane, and the front side wall and the rear side wall may be in vertical planes, and the articulation strips connecting the cover portion with the front side wall or with the rear side wall may have an inclined orientation.

Preferably, the articulation strip between the cover portion and the front side wall or between the cover portion and the rear side wall is a shortened central connecting part, so that blank, at least when in a starting position, has an H-shaped configuration.

In a further form of embodiment corner flaps may adjoin the front side wall and the rear side wall, whereas corner flaps are separated from the front side wall or the rear side wall by folding lines. The corner flaps may be swung up out of the plane of the front side wall or of the rear side wall in a rectangular adjoining plane of a transverse side wall during the erecting operation.

Further it is preferred, when two corner flaps adjoin the front side wall or the rear side wall, the corner flaps may be arranged in the region of mutually opposite sides of these side walls.

The cover arrangement may further comprise transverse side walls being laterally arranged in the region of mutually opposite sides of the cover portion. The transverse side walls adjoin the cover portion preferably approximately at right angles in the end position.

The transverse side wall may comprise at least one carrying section which is fastened or can be fastened to a support structure of the elevator car or the counterweight. Therefore, screw connections may be used. Said support structure for the counterweight may comprise a counterweight carrier frame in which weight elements can be fixed. The counterweight carrier frame may have an upper yoke with two horizontal profiles.

The corner flaps adjoining the front side wall or the rear side wall may be assembled in such a way that they come to lie above or below the corresponding carrying section and are connected thereto in the end position. When the corner flap lies flat above or below the carrying section of the transverse side wall an opening is formed, through which the suspension means run.

The corner flaps as well as the carrying sections of the transverse side walls may comprise at least one hole for fastening the cover arrangement to the support structure of the elevator car or the counterweight. The holes of the corner flaps and the holes of the carrying sections of the transverse side walls may be designed in such a way that, when the cover arrangement is in an end position, the holes of the corner flaps and the respective holes of the carrying sections fit on each other so that a screw passes or can be passed through both holes.

Especially when the cover arrangement outlined above is mounted on top of the deflecting unit a second cover element may be used for covering the lower side of the deflecting unit. It can be advantageous, when a second cover element is arranged on the opposite side of the cover element for an all-around coverage of the deflecting unit. The cover element may be mounted to the support structure in a self-locking manner. Such a cover element may also be used alone without the before mentioned cover arrangement.

Another aspect of the invention refers to a cover arrangement for a deflecting unit of an elevator car or a counterweight for the elevator. The specific features as regards the before described cover arrangement apply to this aspect.

### DESCRIPTION OF THE DRAWINGS

Further features and advantages of the invention are derived from the following description of exemplary embodiments and from the drawings in which:

FIG. 1 is a schematic side view of an elevator,

FIG. 2 shows an extracted and enlarged side view of a deflection unit of a counterweight of an inventive elevator with a cover arrangement (detail A as from FIG. 1),

FIG. 3 is a perspective view of an upper part of a deflection unit for a counterweight of an inventive elevator having a cover arrangement for the deflection unit,

FIG. 4 is a partially exploded perspective view of the deflection unit with the cover arrangement and a cover element,

FIG. 5 is a partially exploded perspective view of a blank for the cover arrangement according to FIG. 4,

FIG. 6 shows a partially erected blank in an intermediate position, and

FIG. 7 shows a fully erected blank (cover arrangement in an end position).

### DETAILED DESCRIPTION

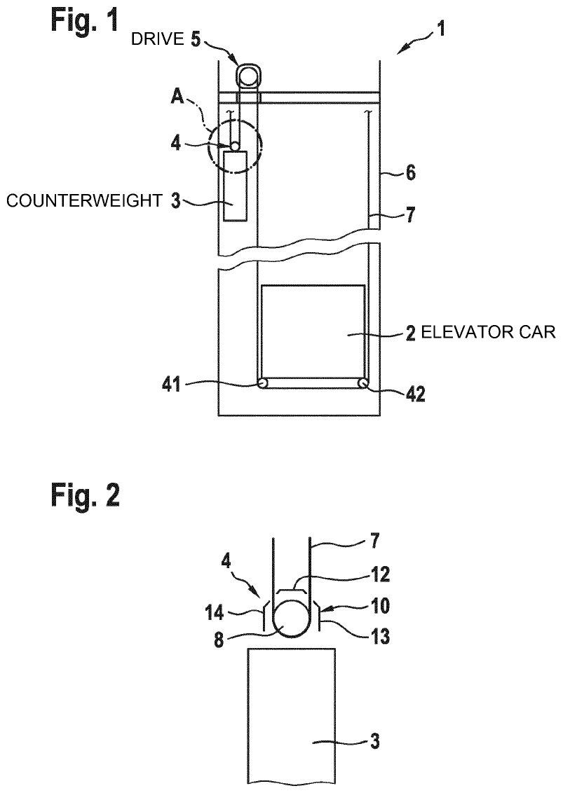

An elevator 1 comprises, as illustrated in FIG. 1 by way of example, an elevator car 2 which is arranged in an elevator shaft 6 to be movable along a substantially vertical axis. The elevator car 2 serves primarily for the movement of persons and/or goods. The elevator car 2 is, in the illustrated example, connected with a counterweight 3 by suspension means 7. Suspension means 7 for supporting the car 2 and the counterweight 3 can be belts or several belts. Obviously, however, other support means, for example in the form of cables, are also conceivable. The elevator car 2 and the counterweight 3 are connected by said suspension means 7, which are guided over deflecting units 4, 41, 42. In the present example, the suspension means 7 suspend the car 2 in the form of an under-looping in a 2:1 suspension and the suspension means 7 are looped around the car 2 by the deflecting units 41, 42. The deflecting unit 4 of the counterweight 3 is arranged on the upper side of the counterweight 4. Further, other suspension variants (for example 4:1, etc.) would obviously also be conceivable. For moving the car 2 and the counterweight 3 use is made of a drive 5, for example a drive-pulley drive, which, for example, is arranged in a separate engine room in the region of the shaft head of the shaft 6. The specific deflecting unit 4 for the counterweight 3 is subsequently described in more detail. Obviously, this deflecting unit 4 may also be suitable for other elevators and, in particular, for so-called engine-room-less elevators.

The deflecting unit 4 for the counterweight 3 can be seen in FIG. 2 in more detail. The deflecting unit 4 comprises a cover arrangement 10 for covering the at least one deflecting roller 8 of the deflecting unit 4. The cover arrangement 10 is mounted on a support structure (not shown here) of the counterweight 3. The cover arrangement 10 is a single-shell cover for dust protection and protection from other external influences. The inventive cover arrangement 10 is a one-piece plastic folding part formed from an erectable blank and thus can be easily installed. Preferably a sturdy comparatively stiff plastic shall be used such as a synthetic plastic polymer (e.g. PE, PP, PU, PVC, etc.). Instead of plastic material the cover arrangement 10 may also be made from other non-metallic material. A very low cost variant of a cover arrangement may be even made from cardboard material.

The cover arrangement 10 comprises a front side wall 13, a cover portion 12 and a rear side wall 14. The cover arrangement 10 is arranged on top of the counterweight 3 and can be installed top down. For a protection from below a second cover (not illustrated here; see FIG. 4, where such a second cover is denoted by 20) may be arranged at the bottom section of the deflecting unit 4.

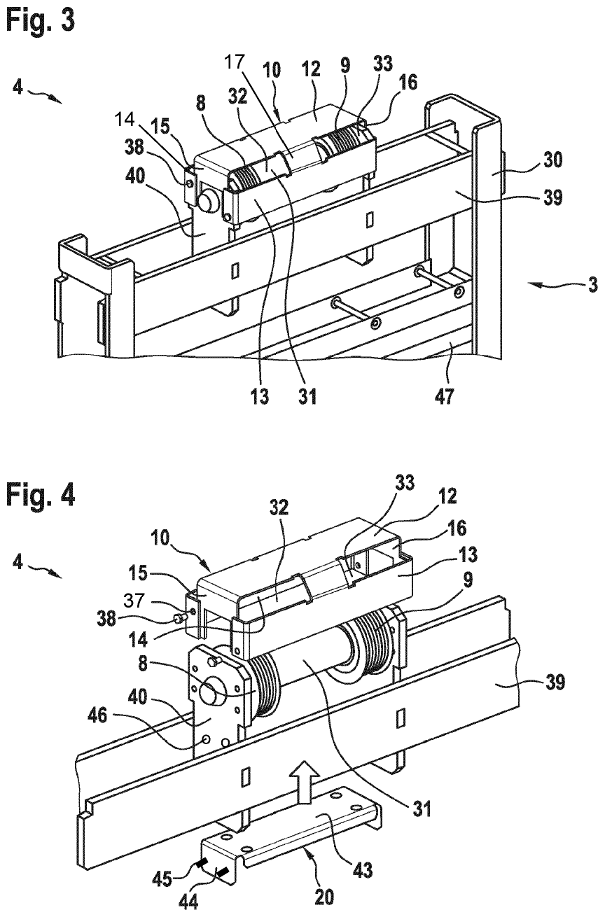

Technical details with respect to the construction of a deflecting unit 4 are apparent from FIG. 3. FIG. 3 shows the upper region of the counterweight 3 and the deflecting unit 4. The counterweight 3 is displaceably guided at guide shoes (not illustrated) at both sides in vertical guide rails (not illustrated here).

The deflecting unit 4 comprises two deflecting rollers 8, 9, at the circumference of which the suspension means (not illustrated here) are guided and deflected. The deflecting rollers 8, 9 are connected with an axle 31 by way of bearings and mounted on the axle 31 to be freely rotatable. The bearings can, for example, contain one or more roller bearings depending on the respective requirements. The axle 31 is fastened to the support structure 30 of the counterweight 3. The Support structure 30 comprises a counterweight carrier frame in which weight elements 47 are kept. The counterweight carrier frame has an upper yoke 39 having two horizontal profiles. The support structure 30 further comprises two vertical support shield plates 40 held in between the profiles of the upper yoke 39. These two mutually opposite shield plates 40, which are each provided with a respective receptacle, through which the axle 31 is guided. The axle 31 is secured in the shield plates 40 on both sides by retaining means. The deflecting rollers 8, 9 are arranged at mutually opposite ends of the axle 31. The axle is an elongated axle having two roller receiving sections for the deflecting rollers 8, 9 and an intermediate shaft portion connecting the roller receiving sections, whereas the intermediate shaft portion has a length dimension with respect to the axial direction which is significantly larger than the ones of the roller receiving sections.

The cover arrangement 10 comprises the horizontal cover portion 12, the vertical front side wall 13, the vertical rear side wall 14 and further two transverse side walls 15, 16 being laterally arranged in the region of mutually opposite sides of the cover portion 12. The transverse side walls 15, 16 connect the front side wall 13 with the rear side wall 14. In the end position as shown in FIG. 3, the side walls 13, 14, 15, 16 adjoin the cover portion 12 at right angles. The transverse side walls 15, 16 are directly adjoining the cover portion 12. The front side wall 13 and the rear side wall 14 are indirectly adjoining the cover portion 12 whereas in between articulation strips 17 are arranged.

FIG. 4 shows the counterweight deflecting unit 4 with the demounted cover arrangement 10. The cover arrangement 10 can be secured and fixed using screws 38. These screws 38 can be screwed in the support shield plates 40. Further, in FIG. 4 can be seen that the deflecting unit 4 comprises a second cover. This second cover is a cover element 20 which is arranged on the opposite side (below) of the cover arrangement 10 for an all-around coverage of the deflecting unit 4. The cover element 20 for a protection from below is arranged at the bottom portion of the deflecting unit 4. The cover element 20 which can be made of plastic material can be mounted to the support structure 30 in a self-locking manner. The cover element 20 comprises a bottom portion 43 and rectangular adjoining side walls 44 located opposite. Lugs or pins 45 arranged on the side walls 44 can engage in corresponding pin openings 46 in the support shield plates 40. The side walls 44 can be slightly flapped inside and inserted in the support structure 30. Thanks to the rebound effect of the side walls 44 adjoining the bottom part 43 a secure connection after the insertion is ensured.

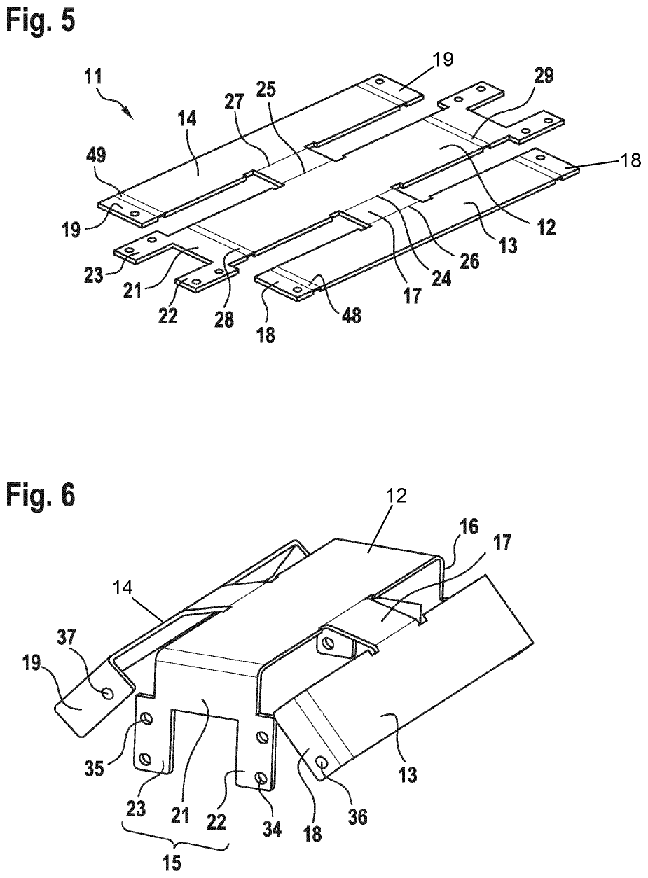

FIG. 5 shows the blank 11 for the cover arrangement. The blank 11 comprises rectangular cover and wall segments surrounded by folding lines or edges. The blank 11 comprising the cover and wall segments lies on a common plane. This position can be regarded as a starting position. The central segment of the blank 11 which is the cover portion 12 is laterally surrounded by the folding lines 28, 29. These folding lines 28, 29 separate the cover portion 12 from the transverse side walls. Towards the front side wall 13 a folding line 24 is located, and towards the rear side wall 14 a folding line 25 is located. The folding lines 24, 25 form upper folds for the articulation strips 17. Lower folds for the articulation strips 17 are formed by folding lines 26, 27. The cover portion 12 and the front side wall 13 on the one side and the cover portion 12 and the rear side wall 14 on the other side are connected by an articulation strip 17. The articulation strips 17 have a longitudinal dimension that is shorter than the longitudinal dimension of the cover portion 12. So, the first articulation strip 17 between the cover portion 12 and the front side wall 13 on the one side and the second articulation strip 17 between the cover portion 12 and the rear side wall 14 on the other side are shortened central connecting parts, which, when in the starting position as shown in FIG. 5, define with respect to a plan view an H-shaped configuration. So, the blank 11 essentially has a form which consists of two adjacent “H”s.

Two corner flaps 18 adjoin the front side wall 13 and two corner flaps 19 adjoin the rear side wall 14, the corner flaps arranged in the region of mutually opposite sides of these side walls 13, 14. The corner flaps 18, 19 are separated from the front side wall 13 or the rear side wall 14 by folding lines 48, 49. The folding lines 24, 25, 26, 27, 28, 29, 48, 49 are preferably formed by prefabricated grooves in the blank 11.

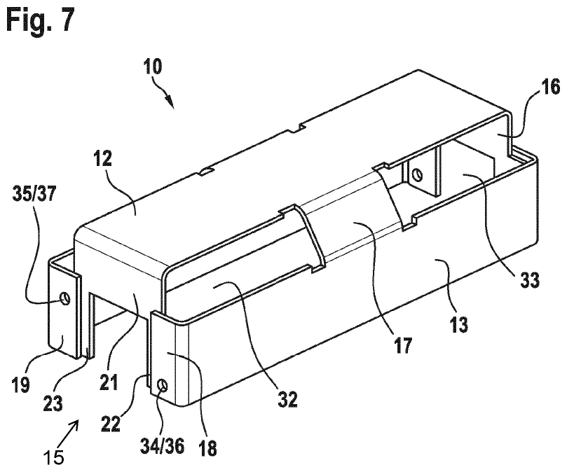

In FIGS. 5-7 the assembly of the cover arrangement 10 is illustrated. FIG. 6 refers to an intermediate position. In this position the transverse side walls 15, 16 adjoin the cover portion 12 at right angles. Each of the transverse side walls 15, 16 comprise a side cover section 21 and two carrying sections 22, 23, whereas the carrying sections 22, 23 can be fastened to a support structure. The carrying sections 22, 23 of the transverse side walls 15, 16 comprise each two holes 34, 35 for fastening the cover arrangement 10 to the support structure 30. Corner flaps 18, 19 adjoin the front side wall 13 and the rear side wall 14 which are separated from the front side wall 13 or the rear side wall 14 by folding lines. Each of the corner flaps 18, 19 comprises a hole 36, 37 which can be brought in operative connection with the holes 34, 35 of the carrying sections 22, 23 of the transverse side walls 15, 16. The corner flaps can be swung up out of the plane of the front side wall 13 or of the rear side wall 14 in a rectangular adjoining plane of a transverse side wall 15 during the erecting operation. The corner flaps 18, 19 adjoining the front side wall 13 or the rear side wall 14 can be assembled in such a way that they come to lie above the corresponding carrying section 22, 23 and are connected thereto during the erecting operation. The holes 34, 35 of the corner flaps 18, 19 and the holes 36, 37 of the carrying sections 22, 23 of the transverse side walls 15, 16 are designed in such a way that, when the cover arrangement 10 is in an end position as shown in FIG. 7, they fit on each other so that the screw 38 passes through both holes 34, 36; 35, 37.

FIG. 7 also shows that, when the corner flap 18, 19 lies above the carrying section 22, 23 of the transverse side wall 15, 16, an opening 32, 33 is formed through which the suspension means (not illustrated here) run (see also FIGS. 3 and 4). The articulation strips 17 connecting the cover portion 12 with the front side wall 13 or with the rear side wall 14 have an inclined orientation.

It could also be envisaged to use the previously described cover arrangement which is a non-metallic folding part formed from an erectable blank also for deflecting units allocated to elevator cars, e.g. when the deflecting unit is arranged on top of the car roof.

In accordance with the provisions of the patent statutes, the present invention has been described in what is considered to represent its preferred embodiment. However, it should be noted that the invention can be practiced otherwise than as specifically illustrated and described without departing from its spirit or scope.

1-15. (canceled)

16. An elevator including an elevator car movable in a shaft and a counterweight, the elevator car and the counterweight being connected by suspension means guided over at least one deflecting roller of a deflecting unit, the deflecting unit being mounted on one of the elevator car and the counterweight, the deflecting unit comprising: a cover arrangement adapted to cover the at least one deflecting roller, the cover arrangement being a non-metallic folding part formed from an erectable blank.

17. The elevator according to claim 16 wherein the cover arrangement is a plastic folding part.

18. The elevator according to claim 16 wherein the erectable blank includes a cover connected to wall segments at folding lines, wherein the cover and the wall segments, in a starting position, lie on a common plane and the cover and the wall segments, in an end position, form a cover portion and side walls respectively, the side walls adjoining the cover portion at right angles.

19. The elevator according to claim 18 wherein the folding lines are formed as prefabricated grooves in the erectable blank.

20. The elevator according to claim 16 wherein the cover arrangement includes a cover portion adjoined by a front side wall and a rear side wall located opposite the front side wall, wherein the cover portion and the front side wall are connected by a first articulation strip and the cover portion and the rear side wall are connected by a second articulation strip.

21. The elevator according to claim 20 wherein when the cover arrangement is in an end position, the cover portion extends in a horizontal plane, the front side wall and the rear side wall extend in separate vertical planes, and the first and second articulation strips are at inclined orientations relative to the horizonal plane and the vertical planes.

22. The elevator according to claim 20 wherein at least one of the first articulation strip and the second articulation strip is a shortened central connecting part such that the erectable blank, at least when in a starting position, has an H-shaped configuration that includes the shortened central connecting part.

23. The elevator according to claim 20 wherein the cover arrangement includes corner flaps adjoining the front side wall and the rear side wall, each of the corner flaps being separated from an associated one of the front side wall and the rear side wall by a folding line, wherein the corner flaps, during an erecting operation performed on the erectable blank, are adapted swing out of a plane of the associated one of the front side wall and the rear side wall into a plane adjoining a transverse side wall connected to the cover portion.

24. The elevator according to claim 23 wherein two of the corner flaps adjoin the front side wall and another two of the corner flaps adjoin the rear side wall.

25. The elevator according to claim 16 wherein the cover arrangement includes a cover portion and two transverse side walls being laterally arranged at opposite edges of the cover portion.

26. The elevator according to claim 25 wherein the transverse side walls each include at least one carrying section adapted to be fastened to a support structure of the elevator car or the counterweight.

27. The elevator according to claim 26 wherein the cover arrangement includes a front side wall and a rear side wall each connected to the cover portion, the front side wall and the rear side wall each including corner flaps, and, in an end position of the cover arrangement, each of the corner flaps lies flat above or below and is connected to an associated one of the carrying sections.

28. The elevator according to claim 27 wherein the corner flaps and the carrying sections each include at least one hole formed therein for fastening the cover arrangement to the support structure of the elevator car or the counterweight.

29. The elevator according to claim 16 including a cover adapted to be mounted to a support structure of the elevator car or the counterweight in a self-locking manner and cooperate with the cover arrangement to provide an all-around coverage of the deflecting unit.

30. A cover arrangement for a deflecting unit of an elevator car or a counterweight of an elevator, the cover arrangement comprising a non-metallic folding part formed from an erectable blank.

31. The cover arrangement according to claim 30 wherein the erectable blank is formed of a plastic material.
